(19) United States
(12) Patent Application Publication
(10) Pub. No.: US 2012/0017062 A1
(43) Pub. Date: Jan. 19, 2012

(54) Data Processing Using On-Chip Memory In Multiple Processing Units

(75) Inventors: Vineet GOEL, Winter Park, FL (US); Todd Martin, Orlando, FL (US); Mangesh Nijasure, Orlando, FL (US)

(73) Assignee: Advanced Micro Devices, Inc., Sunnyvale, CA (US)

(21) Appl. No.: 13/186,038

(22) Filed: Jul. 19, 2011

Related U.S. Application Data
(60) Provisional application No. 61/365,709, filed on Jul. 19, 2010.

(51) Int. Cl. G06F 15/76; G06F 9/06; G06F 12/02

(52) U.S. Cl. 711/170; 712/30; 712/E09.003; 711/E12.002

(57) ABSTRACT

Methods are disclosed for improving data processing performance in a processor using on-chip local memory in multiple processing units. According to an embodiment, a method of processing data elements in a processor using a plurality of processing units, includes: launching, in each of the processing units, a first wavefront having a first type of thread followed by a second wavefront having a second type of thread, where the first wavefront reads as input a portion of the data elements from an off-chip shared memory and generates a first output; writing the first output to an on-chip local memory of the respective processing unit; and writing to the on-chip local memory a second output generated by the second wavefront, where input to the second wavefront comprises a first plurality of data elements from the first output. Corresponding system and computer program product embodiments are also disclosed.

### CROSS REFERENCE TO RELATED APPLICATIONS

This application claims the benefit of U.S. provisional application No. 61/365,709, filed on Jul. 19, 2010, which is hereby incorporated by reference in its entirety.

### BACKGROUND

1. Field of the Invention

The present invention relates to improving the data processing performance of processors.

2. Background Art

Processors with multiple processing units are often employed in parallel processing of large numbers of data elements. For example, a graphics processor (GPU) containing multiple single instruction multiple data (SIMD) processing units is capable of processing large numbers of graphics data elements in parallel. In many cases, the data elements are processed by a sequence of separate threads until a final output is obtained. For example, in a GPU, a sequence of threads of different types, comprising vertex shaders, geometric shaders, and pixel shaders can operate on a set of data items in sequence until a final output is prepared for rendering to a display.

Having multiple separate types of threads to process the data elements at various stages enables pipelining, and thus facilitates an increase of throughput. Each separate thread of a sequence that processes a set of data elements obtains its input from a shared memory and writes its output to the shared memory from where that data can be read by a subsequent thread. Memory access in a shared memory, in general, consumes a large number of clock cycles. As the number of simultaneous threads increase, the delays due to memory access can also increase. In conventional processors with multiple separate processing units that execute large numbers of threads in parallel, memory access delays can cause a substantial slow down in the overall processing speed.

Thus, what are needed are methods and systems to improve the data processing performance of processors with multiple processing, units by reducing the time consumed for memory accesses by a sequence of programs processing a set of data items.

### SUMMARY OF EMBODIMENTS OF THE INVENTION

Methods and apparatus for improving data processing performance in a processor using on-chip local memory in multiple processing units are disclosed. According to an embodiment, a method of processing data elements in a processor using a plurality of processing units, includes: launching, in each of said processing units, a first wavefront having a first type of thread followed by a second wavefront having a second type of thread, where the first wavefront reads as input a portion of the data elements from an off-chip shared memory and generates a first output; writing the first output to an on-chip local memory of the respective processing unit; and writing to the on-chip local memory a second output generated by the second wavefront, where input to the second wavefront comprises a first plurality of data elements from the first output.

Another embodiment is a system including: a processor comprising a plurality of processing units, each processing unit comprising an on-chip local memory; an off-chip shared memory coupled to said processing units and configured to store a plurality of input data elements; a wavefront dispatch module; and a wavefront execution module. The wavefront dispatch module is configured to launch, in each of said plurality of processing units, a first wavefront comprising a first type of thread followed by a second wavefront comprising a second type of thread, the first wavefront configured to read a portion of the data elements from the off-chip shared memory. The wavefront execution module is configured to write the first output to an on-chip local memory of the respective processing unit, and write to the on-chip local memory a second output generated by the second wavefront, where input to the second wavefront includes a first plurality of data elements from the first output.

Yet another embodiment is a tangible computer program product comprising a computer readable medium having computer program logic recorded thereon for causing a processor comprising a plurality of processing units to: launch, in each of said processing units, a first wavefront comprising a first type of thread followed by a second wavefront comprising a second type of thread, wherein the first wavefront reads as input a portion of the data elements from an off-chip shared memory and generates a first output; write the first output to an on-chip local memory of the respective processing unit; and write to the on-chip local memory a second output generated by the second wavefront, wherein input to the second wavefront comprises a first plurality of data elements from the first output.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 is an illustration of a data processing device, according to an embodiment of the present invention.

FIG. 2 is an illustration of an exemplary method of processing data on a processor with multiple processing units according to an embodiment of the present invention.

FIG. 3 is an illustration of an exemplary method of executing a first wavefront on a processor with multiple processing units, according to an embodiment of the present invention.

FIG. 4 is an illustration of an exemplary method of executing a second wavefront on a processor with multiple processors, according to an embodiment of the present invention.

FIG. 5 illustrates a method to determine allocation of thread wavefronts, according to an embodiment of the present invention.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

Embodiments of the present invention may be used in any computer system or computing device in which multiple processing units simultaneously access a shared memory. For example, and without limitation, embodiments of the present invention may include computers, game platforms, entertainment platforms, personal digital assistants, mobile computing devices, televisions, and video platforms.

Most modern computer systems are capable of multi-processing, for example, having multiple processors such as, but not limited to, multiple central processor units (CPU), graphics processor units (GPU), and other controllers, such as memory controllers and/or direct memory access (DMA) controllers, that offload some of the processing from the processor. Also, in many graphics processing devices, a substantial amount of parallel processing is enabled by having, for example, multiple data streams that are concurrently processed.

Such multi-processing and parallel processing, while significantly increasing the efficiency and speed of the system, give rise to many issues including issues due to contention, i.e., multiple devices and/or processes attempting to simultaneously access or use the same system resource. For example, many devices and/or processes require access to shared memory to carry out their processing. But, because the number of interfaces to the shared memory may not be adequate to support all concurrent requests for access, contention arises and one or more system devices and/or processes that require access to the shared memory in order to continue its processing may get delayed.

In a graphics processing device, the various types of processes such as vertex shaders, geometry shaders, and pixel shaders, require access to memory to read, write, manipulate, and/or process graphics objects (i.e., vertex data, pixel data) stored in the memory. For example, each shader may access the shared memory in the read input and write output stages of its processing cycle. A graphics pipeline comprising vertex shaders, geometry shaders, and pixel shaders, help shield the system from some of the memory access delays by concurrently having each type of shader processing sets of data elements in different stages of processing at any given time. When part of the graphics pipeline encounters an increased delay in accessing data in the memory, it can lead to an overall slowdown in system operation and/or added complexity to control the pipeline such that there is sufficient concurrent processing to hide the memory access delays.

In devices with multiple processing units, for example, multiple single instruction multiple data (SIMD) processing units or multiple other arithmetic and logic units (ALU), each unit capable of simultaneously executing a number of threads, contention delays may be exacerbated due to multiple processing devices and multiple threads in each processing device accessing the shared memory substantially simultaneously. For example, in graphics processing devices with multiple SIMD processing units, a set of pixel data is processed by a sequence of “thread groups.” Each processing unit is assigned a wavefront of threads. A “wavefront” of threads is one or more threads from a thread group. Contention for memory access can increase due to simultaneous access requests by threads within a wavefront, as well as due to other wavefronts executing in other processing units.

Embodiments of the present invention utilize on-chip memory local to respective processing units to store outputs of various threads that are to be used as inputs by subsequent threads, thereby reducing the to/from traffic to the off-chip memory. On-chip local memory is small in size relative to off-chip shared memory due to reasons including cost and chip layout. Thus, efficient use of the on-chip local memory is needed. Embodiments of the present invention configure the processor to distribute respective thread waves among the plurality of processing units based on various factors, such as, the data elements being processed at the respective processing units and the availability of on-chip local memory in each processing unit. Embodiments of the present invention enable successive threads executing on a processing unit to read their input from, and write their output to, the on-chip memory rather than the off-chip memory. By reducing the traffic to/from processing units to off-chip memory, embodiments of the present invention improve the speed and efficiency of the systems, and can reduce system complexity by facilitating a shorter pipeline.

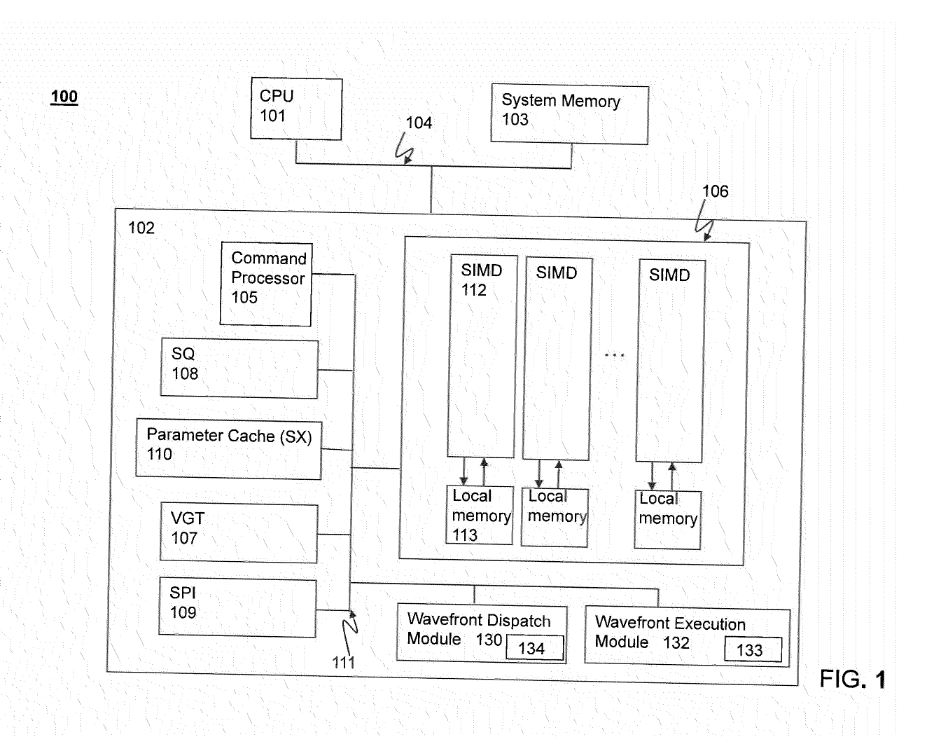

FIG. 1 illustrates a computer system 100 according to an embodiment of the present invention. Computer system 100 includes a control processor 101, a graphics processing device 102, a shared memory 103, and a communication infrastructure 104. Various other components, such as, for example, a display, memory controllers, device controllers, and the like, can also be included in computer system 100. Control processor 101 can include one or more processors such as central processing units (CPU), field programmable gate arrays (FPGA), application specific integrated circuit (ASIC), digital signal processor (DSP), and the like. Control processor 101 controls the overall operation of computer system 100.

Shared memory 103 can include one or more memory units, such as, for example, random access memory (RAM) or dynamic random access memory (DRAM). Display data, particularly pixel data but sometimes including control data, is stored in shared memory 103. Shared memory 103, in the context of a graphics processing device such as here, may include a frame buffer area where data related to a frame is maintained. Access to shared memory 103 can be coordinated by one or more memory controllers (no shown). Display data, either generated within computer system 100 or input to computer system 100 using an external device such as a video playback device, can be stored in shared memory 103. Display data stored in shared memory 103 is accessed by components of graphics processing device 102 that manipulates and/or processes that data before transmitting the manipulated and/or processed display data to another device, such as, for example, a display (not shown). The display can include liquid crystal display (LCD), a cathode ray tube (CRT) display, or any other type of display device. In some embodiments of the present invention, the display and some of the components required for the display, such as, for example, the display controller may be external to the computer system 100. Communication infrastructure 104 includes one or more device interconnections such as Peripheral Component Interconnect Extended (PCI-E), Ethernet, Firewire, Universal Serial Bus (USB), and the like. Communication infrastructure 101 can also include one or more data transmission standards such as, but not limited to, embedded DisplayPort (eDP), low voltage display standard (LVDS), Digital Video Interface (DVI), or High Definition Multimedia Interface (HDMI), to connect graphics processing device 102 to the display.

Graphics processing device 102, according to an embodiment of the present invention, includes a plurality of processing units that each has its own local memory store (e.g., on-chip local memory). Graphics processing device 102 also includes logic to deploy parallelly executing sequences of threads to the plurality of processing units so that the traffic to and from memory 103 is substantially reduced. Graphics processing device 102, according to an embodiment, can be a graphics processing unit (GPU), a general purpose graphics processing unit (GPGPU), or other processing device. Graphics processing device 102, according to an embodiment, includes a command processor 105, a shader core 106, a vertex grouper and tesselator (VGT) 107, a sequencer (SQ) 108, a shader pipeline interpolator (SPI) 109, a parameter cache 110 (also referred to as shader export, SX), a graphics processing device internal interconnection 113, a wavefront dispatch module 130, and a wavefront execution module 132. Other components, such as, for example, scan converters, memory caches, primitive assemblers, a memory controller to coordinate the access to shared memory 103 by processes executing in the shader core 106, a display controller to coordinate the rendering and display of data processed by the shader core 106, although not shown in FIG. 1, may be included in graphics processing device 102.

Command processor 105 can receive instructions for execution on graphics processing device 102 from control processor 101. Command processor 105 operates to interpret commands received from control processor 101 and to issue the appropriate instructions to execution components of the graphics processing device 102, such as, components 106, 107, 108, and 109. For example, upon receiving an instruction to render a particular image on a display, command processor 103 issues one or more instructions to cause components 106, 107, 108, and 109 to render that image. In an embodiment, the command processor can issue instructions to initiate a sequence of thread groups, for example, a sequence comprising vertex shaders, geometry shaders, and pixel shaders, to process a set of vertexes to render an image. Vertex data, for example, from system memory 103 can be brought into general purpose registers accessible by the processing units and the vertex data can then be processed using a sequence of shaders in shader core 106.

Shader core 106 includes a plurality of processing units configured to execute instructions, such as shader programs (e.g., vertex shaders, geometry shaders, and pixel shaders) and other compute intensive programs. Each processing unit 112 in shader core 106 is configured to concurrently execute a plurality of threads, known as a wavefront. The maximum size of the wavefront is configurable. Each processing unit 112 is coupled to an on-chip local memory 113. The on-chip local memory may be any type of dynamic memory, such as static random access memory (SRAM) and embedded dynamic random access memory (EDRAM), and its size and performance may be determined based on various cost and performance considerations. In an embodiment, each processing unit 113 is configured as a private memory of the respective processing unit. The access by a thread executing in a processing unit, to the on-chip local memory has substantially less contention because, according to an embodiment, only the threads executing in the respective processing unit accesses the on-chip local memory.

VGT 107 performs the following primary tasks: it fetches vertex indices from memory, performs vertex index reuse determination such as determining which vertices have already been processed and hence not need to be reprocessed, converts quad primitives and polygon primitives into triangle primitives, and computes tessellation factors for primitive tessellation. In embodiments of the present invention, the VGT can also provide offsets into the on-chip local memory for each thread of respective waveforms, and can keep track of on which on-chip local memory each vertex and/or primitive output from the various shaders are located.

SQ 108 receives the vertex vector data from the VGT 107 and pixel vector data from a scan converter. SQ 108 is the primary controller for SPI 109, the shader core 106 and the shader export 110. SQ 108 manages vertex vector and pixel vector operations, vertex and pixel shader input data management, memory allocation for export resources, thread arbitration for multiple SIMDs and resource types, control flow and ALU execution for the shader processors, shader and constant addressing and other control functions.

SPI 109 includes input staging storage and preprocessing logic to determine and load input data into the processing units in shader core 106. To create data per pixel, a bank of interpolators interpolate vertex data per primitive with, for example, the scan converter's provided barycentric coordinates to create data per pixel for pixel shaders in a manner known in the art. In embodiments of the present invention, the SPI can also determine the size of wavefronts and where each wavefront is dispatched for execution.

SX 110 is an on-chip buffer to hold data including vertex parameters. According to an embodiment, the output of vertex shaders and/or pixel shaders can be stored in SX before being exported to a frame buffer or other off-chip memory.

Wavefront dispatch module 130 is configured to assign sequences of wavefronts of threads to the processing units 112, according to an embodiment of the present invention. Wavefront dispatch module 130, for example, can include logic to determine the memory available in the local memory of each processing unit, the sequence of thread wavefronts to be dispatched to each processing unit, and the size of the wavefront that is dispatched to each processing unit.

Wavefront execution module 132 is configured to execute the logic of each wavefront in the plurality of processing units 112, according to an embodiment of the present invention. Wavefront execution module 132, for example, can include logic to execute the different wavefronts of vertex shaders, geometry shaders, and pixel shaders, in processing units 112 and to store the intermediate results from each of the shaders in the respective on-chip local memory 113 in order to speed up the overall processing of the graphics processing pipeline.

Data amplification module 133 includes logic to amplify or deamplify the input data elements in order to produce an output data element set that is larger than the input data. According to an embodiment, data amplification module 133 includes the logic for geometry amplification. Data amplification, in general, refers to the generation of complex data sets from relatively simple input data sets. Data amplification can result in an output data set having a greater number, lower number, or the same number of data elements as the input data set.

Shader programs 134, according to an embodiment, include a first, second, and third shader program. Processing units 112 execute sequences of wavefronts in which each wavefront comprises a plurality of first, second, or third shader programs. According to an embodiment of the present invention, the first shader program comprises a vertex shader, the second shader program comprises a geometry shader (GS), and the third shader program comprises a pixel shader, a compute shader, or the like.

Vertex shaders (VS) read vertices, process them, and outputs the results to a memory. It does not introduce new primitives. When a GS is active, a vertex shader may be referred to as a type of Export shader (ES). A vertex shader can invoke a Fetch Subroutine (FS), which is a special global program for fetching vertex data that is treated, for execution purposes, as part of the vertex program. In conventional systems, the VS output is directed to either a buffer in system memory or the parameter cache and position buffer, depending on whether a geometry shader (GS) is active. In embodiments of the present invention, the output of the VS is directed to on-chip local memory of the processing unit in which the GS is executing.

Geometry Shaders (GS) read primitives from typically the VS output, and for each input primitive write one or more primitives as output. When GS is active, in conventional systems it requires a Direct Memory Access (DMA) copy program to be active to read/write to off-chip system memory. In conventional systems, the GS can simultaneously read a plurality of vertices from an off-chip memory buffer created by the VS, and it outputs a variable number of primitives to a second memory buffer. According to embodiments of the present invention, the GS is configured to read its input and write its output to on-chip local memory of the processing unit in which the GS is executing.

Pixel Shader (PS) or Fragment Shader, in conventional systems, reads input from various locations including, for example, parameter cache, position buffers associated with the parameter cache, system memory, and VGT. The PS processes individual pixel quads (four pixel-data elements arranged in a 2-by-2 array), and writes output to one or more memory buffers which can include one or more frame buffers. In embodiments of the present invention, PS is configured to read as input the data produced and stored by GS in the on-chip local memory of the processing unit in which the GS is executed.

The processing logic specifying modules 130-134 may be implemented using a programming language such as C, C++, or Assembly. In another embodiment, logic instructions of one or more of 130-134 can be specified in a hardware description language such as Verilog, RTL, and netlists, to enable ultimately configuring a manufacturing process through the generation of maskworks/photomasks to generate a hardware device embodying aspects of the invention described herein. This processing logic and/or logic instructions can be disposed in any known computer readable medium including magnetic disk, optical disk (such as CD-ROM, DVD-ROM), flash disk, and the like.

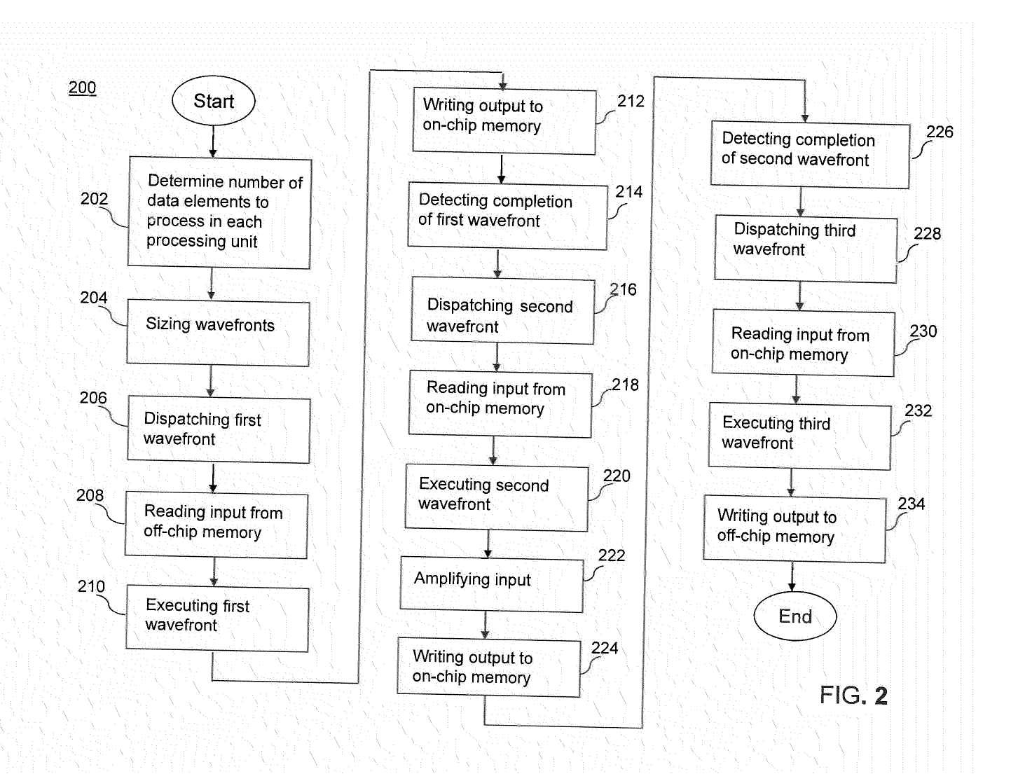

FIG. 2 is a flowchart 200 illustrating the processing of data in a processor comprising a plurality of processing units, according to an embodiment of the present invention. According to embodiments of the present invention, data is processed by a sequence of thread wavefronts, wherein the input to the sequence of threads is read from an off-chip system memory and the output of the sequence of threads is stored in an off-chip memory, but the intermediate results are stored in on-chip local memories associated with the respective processing units.

In step 202, the number of input data elements that can be processed in each processing unit is determined. According to an embodiment, the input data and the shader programs are analyzed to determine the size of the memory requirements for the processing of the input data. For example, the size of the output of each first type of thread (e.g., vertex shader) and the size of output of each second type of thread (e.g., geometry shader) can be determined. The input data elements can, for example, be vertex data to be used in rendering an image. According to an embodiment, the vertex shader processing does not create new data elements, and therefore the output of the vertex shader is substantially the same size as the input. According to an embodiment, the geometry shader can perform geometry amplification, resulting in a multiplication of the input data elements to produce an output of a substantially larger size than the input. Geometry amplification can also result in an output having a substantially lesser size or substantially the same size as the input. According to an embodiment, the VGT determines how many output vertices are generated by the GS for each input vertex. The maximum amount of input vertex data that can be processed in each of the plurality of processing units can be determined based, at least in part, on the size of the on-chip local memory and the memory required to store the outputs of a plurality of threads of the first and second types.

In step 204, the wavefronts are configured. According to an embodiment, based on the memory requirements to store outputs of threads of the first and second types in on-chip local memory of each processing unit, the maximum number of threads of each type of thread can be determined. For example, the maximum number of vertex shader threads, geometry shader threads, and pixel shader threads to process a plurality of input data elements can be determined based on the memory requirements determined in step 202. According to an embodiment, the SPI determines which vertices, and therefore which threads, are allocated to which processing units for processing.

In step 206, the respective first wavefronts are dispatched to the processing units. The first wavefront includes threads of the first type. According to an embodiment, the first wavefront comprises a plurality of vertex shaders. Each first wavefront is provided with a base address to write its output in the on-chip local memory. According to an embodiment, the SPI provides the SQ with the base address for each first wavefront. In an embodiment, the VGT or other logic component can provide each thread in a wavefront with offsets from which to read from, or write to, in on-chip local memory.

In step 208, each of the first wavefronts reads its input from an off-chip memory. According to an embodiment, each first wavefront accesses a system memory through a memory controller to retrieve the data, such as vertices, to be processed. The vertices to be processed by each first wavefront may have been previously identified, and the address in memory of that data provided to the respective first wavefronts, for example, in the VGT. Access to system memory and reading of data elements from system memory, due to contention issues described above, can consume a relatively large number of clock cycles. Each thread within the respective first wavefront determines a base address from which to read its input vertices from the on-chip local memory. The respective base addresses for each thread can be computed based upon, for example, a sequential thread identifier identifying the thread within the respective wavefront, a step size representing the memory space occupied by the input for one thread, and the base address to the block of input vertices assigned to that first wavefront.

In step 210, each of the first wavefronts is executed in the respective processing unit. According to an embodiment, vertex shader processing occurs in step 210. In step 210, each respective thread in a first wavefront can compute its base output address into the on-chip local memory. The base output address for each thread can be, for example, calculated based on a sequential thread identifier identifying the thread within the respective wavefront, the base output address for the respective wavefront, and a step size representing the memory space for each thread. In another embodiment, each thread in the first wavefront can calculate its output base address based on the base output address for the corresponding first wavefront and an offset provided when the thread was dispatched.

In step 212, the output of each of the first wavefronts is written to the respective on-chip local memory. According to an embodiment, the output of each of the threads in each respective first wavefront is written into the respective on-chip local memory. Each thread in a wavefront can write its output to the respective output address determined in step 210.

In step 214, the completion of the respective first wavefronts is determined. According to an embodiment, each thread in a first wavefront can set a flag in on-chip local memory, system memory, general purpose register, or assert a signal in any other manner to indicate to one or more other components of the system that the thread has completed its processing. The flag and/or signal indicating the completion of processing by the first wavefronts can be monitored by components of the system to provide access to the output of the first wavefront to other thread wavefronts.

In step 216, the second wavefront is dispatched. It should be noted that although in FIG. 2 step 216 follows step 214, step 216 can be performed before step 214 in other embodiments. For example, in pipelining thread wavefronts in a processing unit, thread wavefronts are dispatched before the completion of one or more previously dispatched wavefronts. The second wavefront includes threads of the second type. According to an embodiment, the second wavefront comprises a plurality of geometry shader threads. Each second wavefront is provided with a base address to read its input from the on-chip local memory, and a base address to write its output in the on-chip local memory. According to an embodiment, for each second wavefront, the SPI provides the SQ with the base addresses in local memory to read input from and write output to, respectively. The SPI can also keep track of the wave identifier of each thread wavefront and ensure that the respective second wavefronts are assigned to processing units according to the requirements of the data and first wavefronts already assigned to that processing unit. The VGT can keep track of vertices and the processing units to which respective vertices are assigned. The VGT can also keep track of the connections among vertices so that the geometry shader threads can be provided with all the vertices corresponding to their respective primitives.

In step 218, each of the second wavefront reads its input from the on-chip local memory. Access to on-chip memory local to the respective processing units, is fast relative to access to system memory. Each type within the respective second wavefront determines a base address from which to read its input data from the on-chip local memory. The respective base addresses for each thread can be computed based upon, for example, a sequential thread identifier identifying the thread within the respective wavefront, a step size representing the memory space occupied by the input for one thread, and the base address to the block of input vertices assigned to that second wavefront.

In step 220, each of the second wavefronts is executed in the respective processing unit. According to an embodiment, geometry shader processing occurs in step 220. In step 220, each respective thread in a second wavefront can compute its base output address into the on-chip local memory. The base output address for each thread can be, for example, calculated based on a sequential thread identifier identifying the thread within the respective wavefront, the base output address for the respective wavefront, and a step size representing the memory space for each thread. In another embodiment, each thread in the second wavefront can calculate its output base address based on the base output address for the corresponding second wavefront and an offset provided when the thread was dispatched.

In step 222, the input data elements read in by each of the threads of the second wavefronts are amplified. According to an embodiment, each of the geometry shader threads performs processing that results in geometry amplification.

In step 224, the output of each of the second wavefronts is written to the respective on-chip local memory. According to an embodiment, the output of each of the threads in each respective second wavefront is written into the respective on-chip local memory. Each thread in a wavefront can write its output to the respective output address determined in step 216.

In step 226, the completion of the respective second wavefronts is determined. According to an embodiment, each thread in a second wavefront can set a flag in on-chip local memory, system memory, general purpose register, or assert a signal in any other manner to indicate to one or more other components of the system that the thread has completed its processing. The flag and/or signal indicating the completion of processing by the second wavefronts can be monitored by components of the system to provide access to the output of the second wavefront to other thread wavefronts. Upon the completion of the second wavefront, in an embodiment, the on-chip local memory occupied by the output of the corresponding first wavefront can be deallocated and made available.

In step 228 the third wavefront is dispatched. The third wavefront includes threads of the third type. According to an embodiment, the third wavefront comprises a plurality of pixel shader threads. Each third wavefront is provided with a base address to read its input from the on-chip local memory. According to an embodiment, for each third wavefront, the SPI provides the SQ with the base addresses in local memory to read input from and write output to, respectively. The SPI can also keep track of the wave identifier of each thread wavefront and ensure that the respective third wavefronts are assigned to processing units according to the requirements of the data and third wavefronts already assigned to that processing unit.

In step 230, each of the third wavefronts reads its input from the on-chip local memory. Each type within the respective third wavefront determines a base address from which to read its input data from the on-chip local memory. The respective base addresses for each thread can be computed based upon, for example, a sequential thread identifier identifying the thread within the respective wavefront, a step size representing the memory space occupied by the input for one thread, and the base address to the block of input vertices assigned to that third wavefront.

In step 232, each of the third wavefronts is executed in the respective processing unit. According to an embodiment, pixel shader processing occurs in step 232.

In step 234, the output of each of the third wavefronts is written to the respective on-chip local memory, system memory, or elsewhere. Upon the completion of the third wavefront, in an embodiment, the on-chip local memory occupied by the output of the corresponding second wavefront can be deallocated and made available.

One or more additional processing steps can be included in method 200, based on the application. According to an embodiment, the first, second, and third wavefronts comprise vertex shaders and geometry shaders, launched so as to create a graphics processing pipeline to process pixel data and render an image to a display. It should be noted that the ordering of the various types of wavefronts is dependent on the particular application. Also, according to an embodiment, the third wavefront can comprise pixel shaders and/or other shaders such as compute shaders and copy shaders. For example, a copy shader can compact the data and/or write to global memories. By writing the output of one or more thread wavefronts to the on-chip local memory associated with a processing unit, embodiments of the present invention substantially reduces the delays due to contention for memory access.

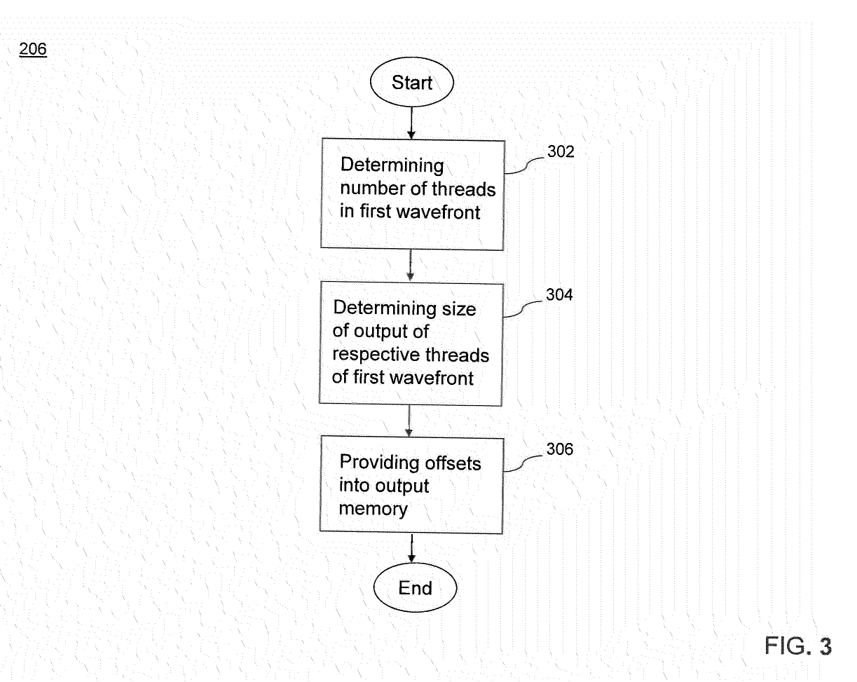

FIG. 3 is a flowchart of method (302-306) to implement step 206, according to an embodiment of the present invention. In step 302, the number of threads in each respective first wavefront is determined. This can be determined based on various factors, such as, but not limited to, the data elements to be available to be processed, the number of processing units, the maximum number of threads that can simultaneously execute on each processing unit, and the amount of available memory in the respective on-chip local memories associated with the respective processing units.

In step 304, the size of output that can be stored by each thread of the first wavefront is determined. The determination can be based upon preconfigured parameters, or dynamically determined parameters based on program instructions and/or size of the input data. According to an embodiment, the size of output that can be stored by each thread of the first wavefront, also referred to herein as the step size of the first wavefront, can be either statically or dynamically determined at the time of launching the first wavefront or during execution of the first wavefront.

In step 306, each thread is provided with an offset into the on-chip local memory associated with the corresponding processing unit to write its respective output. The offset can be determined based on a sequential thread identifier identifying the thread within the respective wavefront, the base output address for the respective wavefront, and a step size representing the memory space for each thread. During processing, each respective thread can determine the actual offset in the local memory to which it should write its output based on the offset provided at the time of thread dispatch, the base output address for the wavefront, and the step size of the threads.

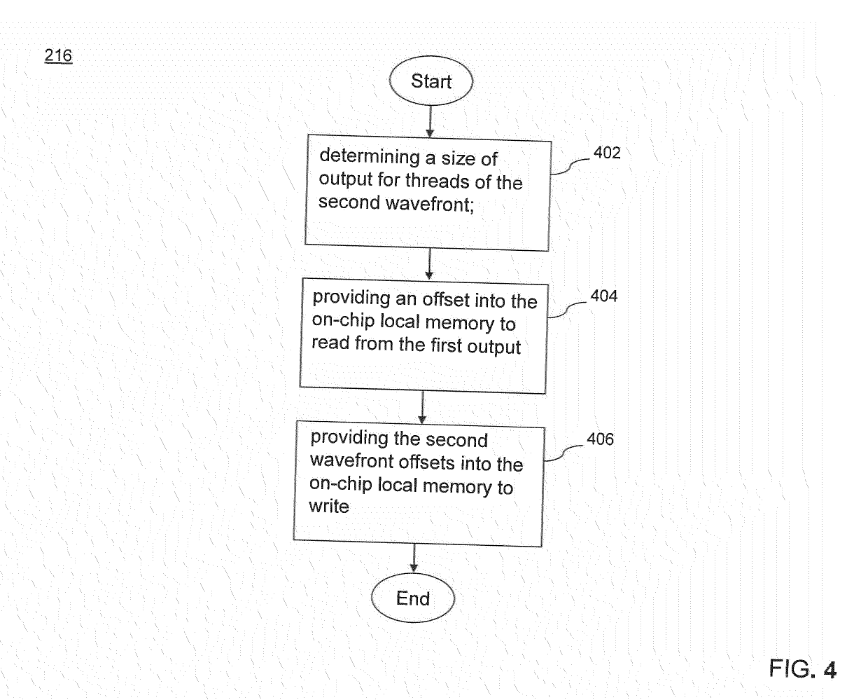

FIG. 4 is a flowchart illustrating a method (402-406) for implementing step 216, according to an embodiment of the present invention. In step 402, a step size for the threads of the second wavefront is determined. The step size can be determined based on the programming instructions of the second wavefront, a preconfigured parameter specifying a maximum step size, a combination of a preconfigured parameter and programming instructions, or like method. According to an embodiment, the step size should be determined so as to accommodate data amplification, such as geometry amplification by a geometry shader, of the input data read by the respective threads of the second wavefront.

In step 404, each thread in respective second wavefronts can be provided with a read offset to determine the location in the on-chip local memory from which to read its input. Each respective thread can determine the actual read offset, for example, during execution, based on the read offset, the base read offset for the respective wavefront, and the step size of the threads of the corresponding first wavefront.

In step 406, each thread in respective second wavefronts can be provided with a write offset into the on-chip local memory. Each respective thread can determine the actual write offset, for example, during execution, based on the write offset, the base write offset for the respective wavefront, and the step size of the threads of the second wavefront.

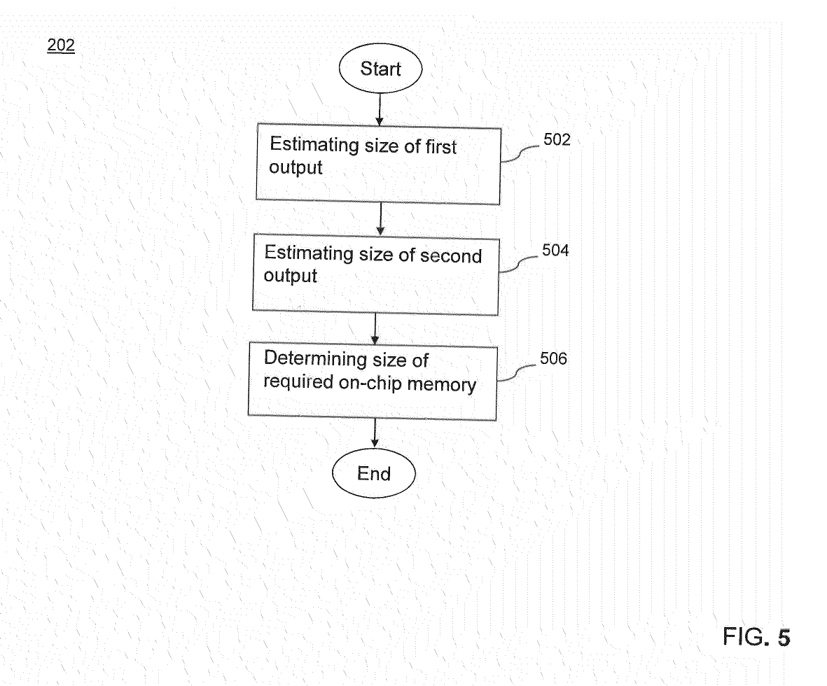

FIG. 5 is a flowchart illustrating a method (502-506) of determining data elements to be processed in each of the processing units. In step 502, the size of the output of the first wavefront to be stored in the on-chip local memory of each processing unit is estimated. According to an embodiment, the size of the output is determined based on the number of vertices to be processed by a plurality of vertex shader threads. The number of vertices to be processed in each processing unit can be determined based upon factors such as, but not limited to, the total number of vertices to be processed, number of processing units available to process the vertices, the amount of on-chip local memory available for each processing unit, and the processing applied to each input vertex. According to an embodiment, each vertex shader outputs the same number of vertices that it read in as input.

In step 504, the size of the output of the second wavefront to be stored in the on-chip local memory of each processing unit is estimated. According to an embodiment, the size of the output of the second wavefront is estimated based, at least in part, upon an amplification of the input data performed by respective threads of the second wavefront. For example, processing by a geometry shader can result in geometry amplification giving rise to a different number of output primitives than input primitives. The magnitude of the data amplification (or geometry amplification) can be determined based on a preconfigured parameter and/or aspects of the programming instructions in the respective threads.

In step 506, the size of the required available on-chip local memory associated with each processor is determined by summing the size of outputs of the first and second wavefronts. According to an embodiment of the present invention, the on-chip local memory of each processing unit is required to have available at least as much memory as the sum of the output sizes of the first and second wavefronts. The number of vertices to be processed in each processing unit can be determined based on the amount of available on-chip local memory and the sum of the outputs of a first wavefront and a second wavefront.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of processing data elements in a processor using a plurality of processing units, comprising:
launching, in each of said processing units, a first wavefront comprising a first type of thread followed by a second wavefront comprising a second type of thread, wherein the first wavefront reads as input a portion of the data elements from an off-chip shared memory and generates a first output;
writing the first output to an on-chip local memory of the respective processing unit; and
writing to the on-chip local memory a second output generated by the second wavefront, wherein input to the second wavefront comprises a first plurality of data elements from the first output.

2. The method of claim 1, further comprising:
processing, using the second wavefront, the first plurality of data elements to generate the second output, wherein the number of data elements in the second output is substantially different from that of the first plurality of data elements.

3. The method of claim 2, further comprising:
The method of claim 2, wherein the number of data elements in the second output is dynamically determined.

4. The method of claim 2, wherein the second wavefront comprises one or more geometry shader threads.

5. The method of claim 4, wherein the second output is generated by geometry amplification of the first output.

6. The method of claim 1, further comprising:
executing a third wavefront in the first processing unit following the second wavefront, wherein the third wavefront reads the second output from the on-chip local memory.

7. The method of claim 1, further comprising:
determining, for the respective processing unit, a number of said data elements to be processed based at least upon available memory in the on-chip local memory; and
sizing, for the respective processing unit, the first and second wavefronts based upon the determined number.

8. The method of claim 7, wherein the determining comprises:
estimating a memory size of the first output;
estimating a memory size of the second output; and
calculating a required on-chip memory size using the estimated memory sizes of the first and second output.

9. The method of claim 1, wherein the launching comprises:
executing the first wavefront;
detecting a completion of the first wavefront; and
reading the first output by the second wavefront subsequent to the detection.

10. The method of claim 9, wherein the executing the first wavefront comprises:
determining a size of output for respective threads of the first wavefront; and
providing an offset for output into the on-chip local memory to each of the respective threads of the first wavefront.

11. The method of claim 9, wherein the launching further comprises:
determining a size of output for respective threads of the second wavefront;
providing an offset into the on-chip local memory to read from the first output to the respective threads of the second wavefront; and
providing to each thread of the second wavefront an offset into the on-chip local memory to write a respective portion of the second output.

12. The method of claim 11, wherein a size of the output for respective threads of the second wavefront is based on a predetermined geometry amplification parameter.

13. The method of claim 1, wherein each of said plurality of processing units is a single instruction multiple data (SIMD) processor.

14. The method of claim 1, wherein the on-chip local memory is accessible only to threads executing on the corresponding respective processing unit.

15. The method of claim 1, wherein the first wavefront and the second wavefront comprise respectively of vertex shader threads and geometry shader threads.

16. A system comprising:
a processor comprising a plurality of processing units, each processing unit comprising an on-chip local memory;
an off-chip shared memory coupled to said processing units and configured to store a plurality of input data elements;
a wavefront dispatch module coupled to the processor, and configured to:
launch, in each of said plurality of processing units, a first wavefront comprising a first type of thread followed by a second wavefront comprising a second type of thread, the first wavefront configured to read a portion of the data elements from the off-chip shared memory; and
a wavefront execution module coupled to the processor, and configured to:
write the first output to an on-chip local memory of the respective processing unit; and
write to the on-chip local memory a second output generated by the second wavefront, wherein input to the second wavefront comprises a first plurality of data elements from the first output.

17. The system of claim 16, wherein the wavefront execution module is further configured to:
process, using the second wavefront, the first plurality of data elements to generate the second output, wherein the number of data elements in the second output is substantially different from that of the first plurality of data elements.

18. The system of claim 17, wherein the second output is generated by geometry amplification of the first output.

19. The system of claim 18, wherein the first and second wavefronts comprise, respectively, vertex shader threads and geometry shader threads.

20. A tangible computer program product comprising a computer readable medium having computer program logic recorded thereon for causing a processor comprising a plurality of processing units to:
launch, in each of said processing units, a first wavefront comprising a first type of thread followed by a second wavefront comprising a second type of thread, wherein the first wavefront reads as input a portion of the data elements from an off-chip shared memory and generates a first output;
write the first output to an on-chip local memory of the respective processing unit; and
write to the on-chip local memory a second output generated by the second wavefront, wherein input to the second wavefront comprises a first plurality of data elements from the first output.
